(19) United States
(12) Patent Application Publication
(10) Pub. No.: US 2010/0098114 A1
(43) Pub. Date: Apr. 22, 2010

(54) Frequency Control Method and Apparatus

(75) Inventors: Jolyon DeFreitas, Dorset (GB); David John Hill, Dorset (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/593,531

(22) PCT Filed: Mar. 28, 2008
(86) PCT No.: PCT/GB2008/001065

§ 371 Date: Sep. 28, 2009

(30) Foreign Application Priority Data
Apr. 3, 2007 (GB) 0706453.8

(51) Int. Cl. H01S 3/30; H01S 3/00; B23P 11/00; B22D 19/04

(52) U.S. Cl. 372/6; 372/38.01; 29/428; 164/112

(57) ABSTRACT

A feedback control circuit and method for controlling laser frequency employing an interferometric phase sensor which accepts a light output from a laser and combines a phase modulated version of the light output, with an unmodulated version. By modulating only one component of the signal in the interferometric sensor, the improved noise characteristics are obtained, while demodulation can be performed relatively easily and cheaply. Methods and enclosures for reducing ambient noise in an interferometer or the delay coil thereof are also described.

The present invention relates to the frequency control of lasers, and more particularly to the control of frequency drift or jitter in fibre lasers.

Fibre lasers are used extensively in fibre laser sensing and communications. In recent years there have been several demonstrations of various technologies involving seismic and other oil and gas applications. Fibre sensing lasers are generally pumped with a 980 nm pump laser and emit in the 1550 nm region.

One of the major issues in the application of fibre lasers to fibre optic sensing is the inherent drift (or, jitter) in laser frequency which translates directly into laser phase noise in an interferometer. A typical fibre laser would tend to show a frequency jitter of the order of a few hundreds of rad/s. While this meets the needs of most fibre sensing applications, in seismic systems this introduces unwanted noise into the measurement process.

It is therefore an object of the present invention to provide improved laser frequency control.

Accordingly, in a first aspect of the invention there is provided a feedback control circuit for controlling laser frequency comprising a laser assembly having a light output and a control input for modifying the frequency of the output light; an interferometric phase sensor acting on said light output to produce a modulated phase output; and a demodulator for demodulating said phase output and providing a control signal to said frequency control input to compensate for laser frequency drift; wherein said interferometric phase sensor combines a phase modulated version of said light output, with an unmodulated version.

Modulation of the phase information results in improved noise characteristics, however demodulation inevitably adds complexity to the overall system or circuit. By modulating only one component of the signal in the interferometric sensor however, the improved noise characteristics are retained while demodulation can be performed relatively easily and cheaply as will be discussed in greater detail below.

In a preferred embodiment the laser assembly is a fibre laser assembly and in such an arrangement the interferometric sensor is conveniently a fibre interferometer.

In a particularly preferred embodiment the interferometer employs Faraday rotating mirrors. Using such mirrors in both arms of the interferometer can result in the frequency resolution of the control system being determined by the intrinsic sensitivity of interferometer, since the effects of polarisation on visibility are reduced compared to other systems.

A phase modulator, which may be implemented as a fibre-fed acousto-optic modulator, acts on one arm of the interferometer in certain embodiments.

In embodiments where the interferometric sensor includes a delay coil and it is desired to reduce further the effects of noise, the delay coil is enclosed in a noise reduction casing. Alternatively the entire interferometric sensor may be enclosed in such a casing, however it is isolation of the coil which provides the majority of the performance advantage. The casing is preferably substantially evacuated, or alternatively ma be filled with a low melting point solid in order to attenuate or eliminate the effects of external noise or vibrations on the system.

Such noise reduction may be provided independently, and accordingly in a second aspect of the invention there is provided a fibre optic component including a fibre optic coil, wherein said coil is enclosed within a noise reducing housing such that the enclosed space surrounding said coil has reduced acoustic transmission.

A related, third aspect of the invention provides a method of producing a fibre optic component comprising the steps of providing an enclosure having at least one input/output port, arranging the component in the enclosure with an input/output fibre of the component passing through said at least one port, locating the component within the enclosure using resiliently deformable spacers such that the component is free of contact with the enclosure walls, and substantially evacuating the enclosure.

Also related, a fourth aspect of the invention provides a method of producing a fibre optic component comprising the steps of providing an enclosure having at least one input/output port, arranging the component in the enclosure with an input/output fibre of the component passing through said at least one port, filling the enclosure with a molten metal, and allowing the metal to solidify

Preferably the metal has a melting point less than or equal to 100 or more preferably 75 degrees centigrade, and preferably the metal has a density greater than or equal to 7 or more preferably 9 g/cm³. A high density results in a low acoustic conductance (high acoustic impedance).Suitable metals include Fields metal, Woods metal, and a number of materials produced by the Cerro metal products company (www.cerrometal.com) having Cerro alloy numbers 4470-2, 5000-7, 5700-1 for example.

The invention extends to methods apparatus and/or use substantially as herein described with reference to the accompanying drawings.

Any feature in one aspect of the invention may be, applied to other aspects of the invention, in any appropriate combination. In particular, method aspects may be applied to apparatus aspects, and vice versa.

Preferred features of the present invention will now be described, purely by way of example, with reference to the accompanying drawings, in which:

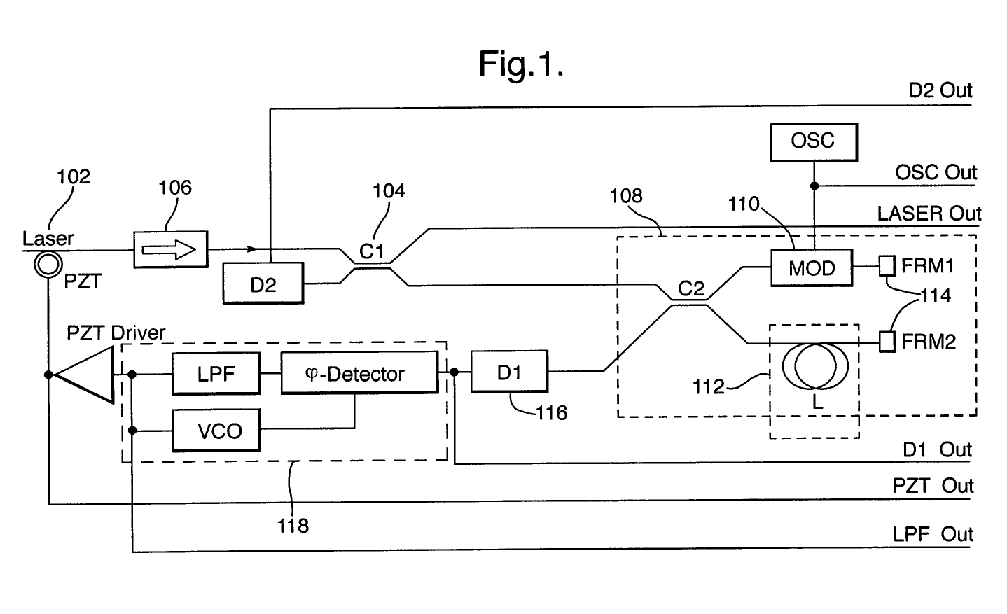

FIG. 1 shows a first embodiment of a control circuit according to an aspect of the invention

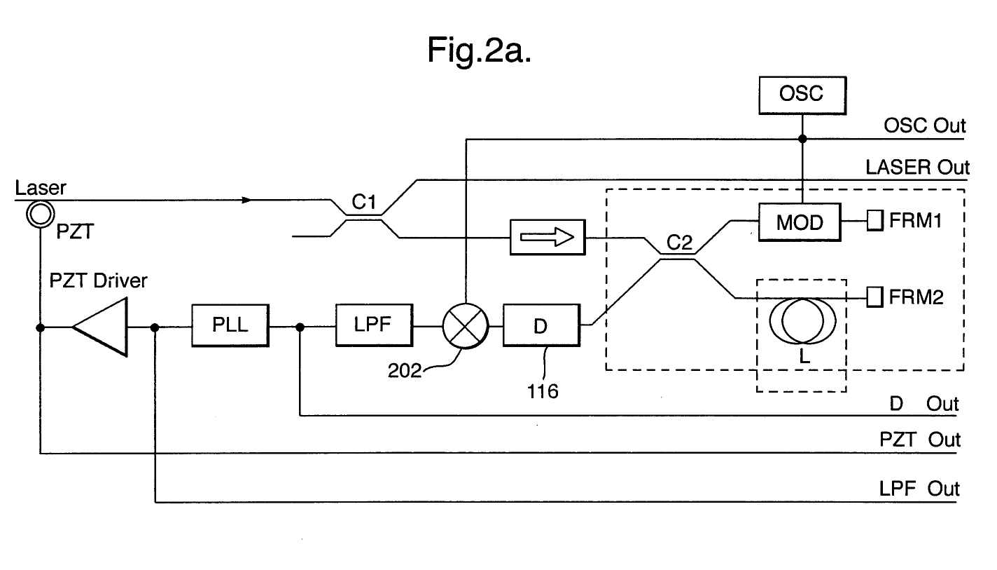

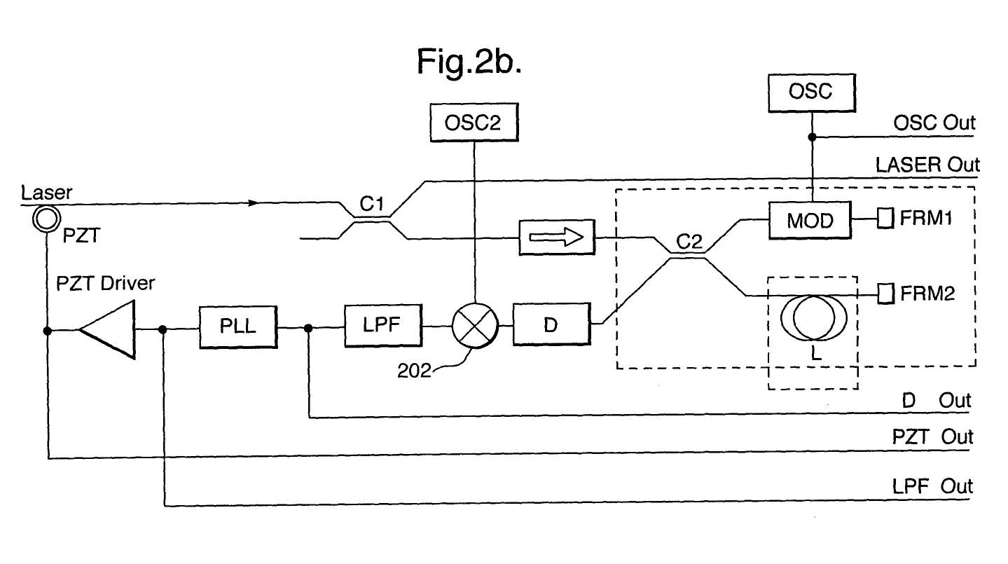

FIGS. 2a and 2b show embodiments of the invention employing down conversion.

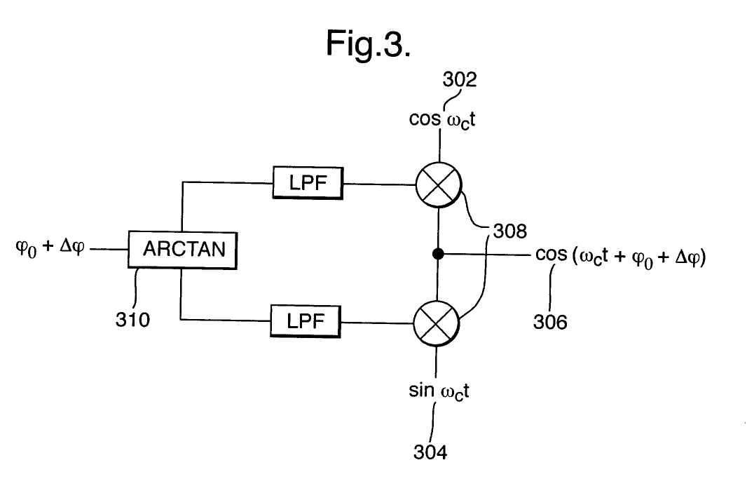

FIG. 3 shows a digital demodulator.

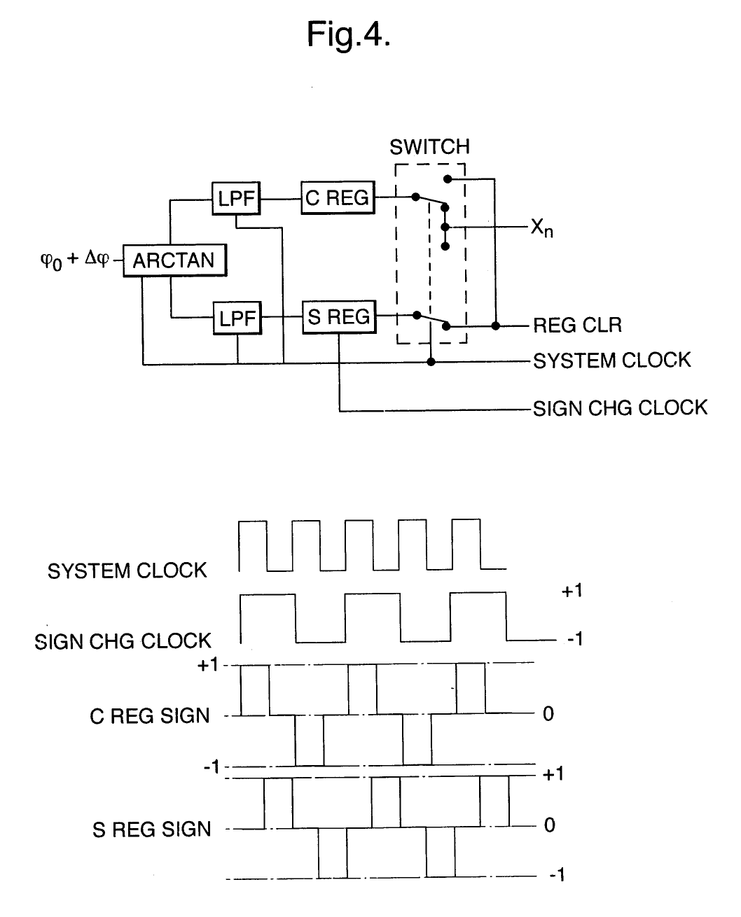

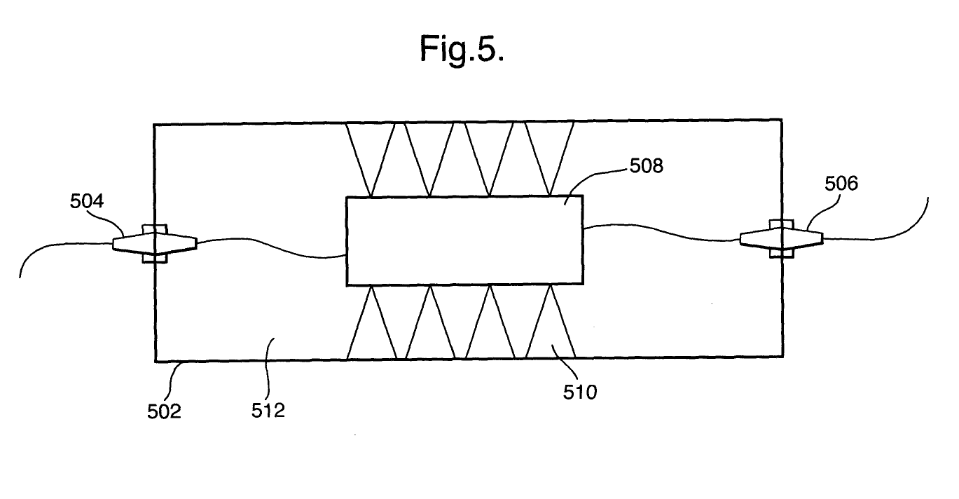

FIG. 4 illustrates an alternative digital demodulation scheme for a particular frequency relationship.

FIG. 5 is a schematic of a noise reduction arrangement according to an aspect of the invention.

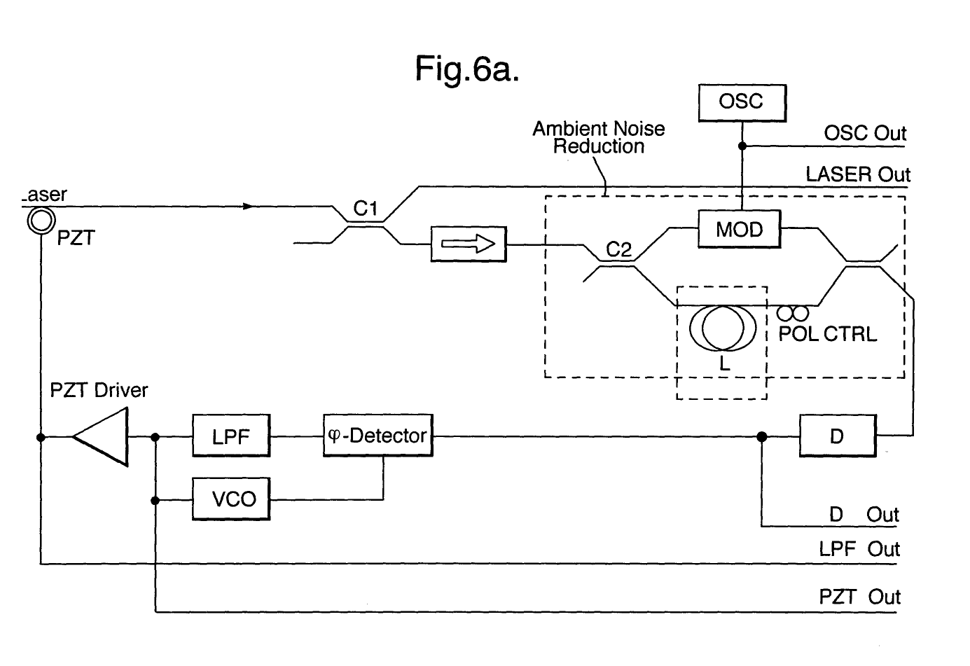

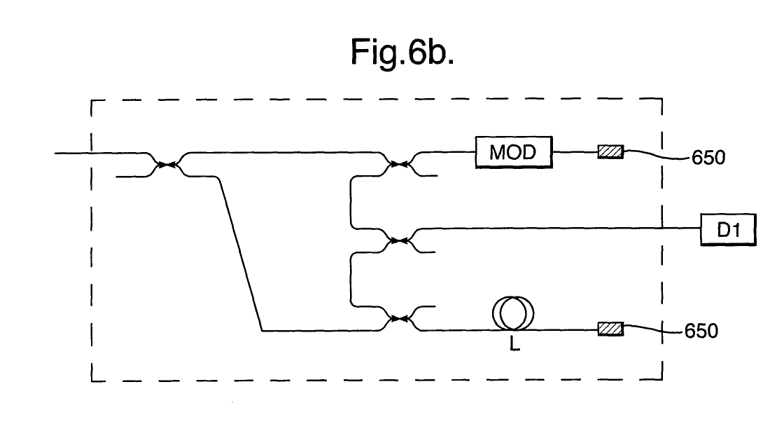

FIGS. 6a and 6b show Mach-Zehnder implementations of aspects of the invention.

Referring to FIG. 1, a fibre laser 102 is wound on a spool or former of piezoelectric material such as Lead Zirconate Titanate (PZT), or other piezo-ceramic material, such that the application of a voltage causes the fibre to stretch the laser cavity which in turn leads to a change in laser frequency. This is the principal proposed mechanism for controlling the laser wavelength, although other means are possible, e.g. mounting the laser on a device which expands or contracts via thermal means.

A first embodiment of this system would involve tapping off a portion of the laser light output from the laser via a tap coupler 104. Prior to the tap off point the output light passes through an optical isolator 106. The tapped off light enters a Michelson fibre interferometer 108 where one arm of the interferometer contains a phase modulator (MOD) 110, which may be formed by a fibre-fed acousto-optic modulator. The second arm of the interferometer contains a long delay coil 112 of length L, which amplifies the laser frequency jitter to make it observable. Faraday rotating mirrors 114 are attached to the two arms of the interferometer. The visibility of the device is affected by changes in polarisation state that occurs along the fibre path, and hence incorporation of the mirrors in this configuration improves visibility.

The light entering the photodetector 116 contains the sum of the two ray bundles from the arms of the interferometer, i.e., ae^{j(2ω}^{_{c}}^{i+φ}^{₁}⁾ and be^{jφ}^{₂}, where ω_{c} is the imposed carrier frequency of the AOM, usually in the tens of MHz region, φ₁ is the phase acquired in the modulation arm of the interferometer, φ₂ is the phase acquired in the delay arm, and a and b are the electric field amplitudes through the modulation and delay arms respectively. The two beams are combined in D1 to give

$$I = {I}_{0} [ 1 + V cos ( 2 {ω}_{c} t + {ϕ}_{0} + Δ ϕ ) ] where {ϕ}_{0} = 4 π nL \frac{\overline{v}}{c} , \\ Δ ϕ = 4 π nL \frac{Δ v}{c} , \qquad ( 1 )$$

Δv is the laser frequency jitter, L is the difference in optical path length between the delay and modulation arm, and v̅ is the mean laser frequency over time. In practice the delay arm is very much larger (˜10³)

than the modulation arm. Note that the factor 2 in (1) accounts for the second pass of the reflected beam through the modulator. Additionally, φ₀+Δφ is also the phase difference between the arms of the interferometer.

The signal detected at photodetector 116 is demodulated by a phase locked loop (PLL) 118. The carrier frequency at 2ω_{c} enters a phase detector which also has an input from a voltage controlled oscillator (VCO). The phase difference between the VCO signal and the incoming interferometer signal is low pass filtered (LPF) which is then used to drive the VCO and bring it into lock. At lock, the LPF signal will drive the VCO so that the phase difference between the incoming interferometer signal and VCO are in phase. As such, the LPF output signal is the demodulated phase information (φ₀+Δφ) which is then used to drive the control input of the laser 102.

In this arrangement, the laser control driver signal causes the laser to compensate for both φ₀+Δφ. This is more clearly understood by considering a first cycle of a ray of light emerging from an uncompensated laser, where the signal detected at the photodetector 116 is demodulated by a phase locked loop (PLL), although other suitable demodulation techniques could be used (see below). The ray of light emerging from the output of the interferometer has a carrier frequency of 2ω_{c}. The said ray of light is then converted to an electrical signal in the photodetector 116 and enters one input of the phase detector of the PLL, while the second input comes from the voltage controlled oscillator (VCO). At this stage there is a phase difference between the photodetector signal and the VCO. The said phase difference is low pass filtered (LPF) to produce a correction signal which is proportional to the laser frequency jitter and used by the PZT driver to change the laser cavity length to compensate for the changes in the laser frequency.

In the second cycle, the mean laser frequency v̅ is changed to compensate for the constant offset (or slowly changing) φ₀ existing in the interferometer, due to the path imbalance and associated environmental effects, and the intrinsic jitter of the laser Δv. The correction signal from the first cycle is also used to change the VCO to a frequency that resembles the incoming second cycle signal from the photodetector. Over many such cycles the two signals entering the phase detector of the PLL become phase matched so that there is no phase difference between them, leading to a fully compensated laser, except for slow changes that occurs in the interferometer. The slower change in the interferometer can be managed by passively controlling the environmental effects on the interferometer as a whole, or on components such as the delay coil of the interferometer.

In this configuration there is no need to lock the interferometer onto the quadrature point, i.e. φ₀=π/2, since the system automatically compensates for both quadrature and laser frequency drift simultaneously. φ₀ is expected to be relatively slow in relation to both the carrier frequency and the laser frequency jitter.

Typical bandwidth requirements for seismic applications are approximately 1 kHz. If the AOM runs at about 20 MHz, then the PLL loop bandwidth can be at least 10 kHz, superseding the usual seismic applications, while locking to 40 MHz carrier.

FIGS. 2a and 2b illustrate embodiments in which the AOM frequency is down-converted prior to the PLL i.e. electrical down-conversion after the detector 116, by mixing it with the oscillator OSC (as in FIG. 2a) or a second oscillator OSC2 (as in FIG. 2b) in a balanced four-quadrant analogue mixer 202, then low pass filtering. Such an embodiment is useful if the AOM frequency is greater than desired. Frequency down-conversions are driven by the complexity of the RF electronics layout and control.

An alternative to the PLL is to use an analogue phase detector. An analogue phase detector consists of a phase detector followed by an integrator or low-pass filter. The integrator or low-pass filter could be either analogue or digital, with the latter requiring an ADC behind the phase detector, or alternatively using the built-in phase detection logic found in programmable logic arrays.

A digital implementation of the signal processing is possible if the phase-locked loop is replaced by a digital demodulator. In this implementation the signal obtained from the detector D is converted into digital signals through an analogue to digital converted (ADC) and passed to a microprocessor or digital signal processor which implements the demodulation. The demodulated phase from the microprocessor is then converted back into an analogue signal via a digital to analogue converter (DAC) which is then used to control the PZT driver. The demodulator is shown in FIG. 3. Sinusoidal inputs 302 and 304 are obtained from the oscillator at the modulation frequency and multiplied with the signal 306 obtained from the detector at multipliers 308. The results are low passed filtered and then used together in an arctan function 310 which outputs demodulated (digital) phase information.

If the carrier frequency is half the Nyquist frequency i.e., sampling frequency/4, then there is no need to carry out full multiplication because in this case, cos ω_{c}t and sin ω_{c}t become a stream of 1s, 0s, and −1s. As such, rather than carrying out full multiplication, one could easily change the sign of every other sample and zeroing all others. The phasing of the cos ω_{c}t and sin ω_{c}t will be readily apparent to the skilled person. This is shown in FIG. 4 where incoming digitised sample Xₙ is switched between the cosine register (C REG) and the sine register (S REG) whereupon every two samples the sign of the register is changed by the sign change clock (SIGN CHG CLOCK). When the switch is not pointing to the sample stream, the register is reset to zero by REG CLR. The whole system is clocked with the system clock (SYS CLOCK). A timing diagram is also shown in FIG. 4. The combination of the system clock and the sign change clock leads to the data in the cosine register and sine register following the C REG SIGN and S REG SIGN as shown in the figure. Filtering (LPF) and the ARCTAN operation are digital in nature.

Because the above described embodiments use a Michelson configured interferometer, the frequency resolution of the control system is determined by the intrinsic sensitivity of the Michelson fibre interferometer,

$$\frac{Δ ϕ}{Δ v} \approx 6 \times {10}^{- 5}$$

radian Hz⁻¹ m⁻¹ and not the visibility as in homodyne systems (which must be locked to φ₀=π/2). However, the consequence of this is that longer path imbalances are desirable, typically a few km, to achieve a practical laser frequency jitter resolution, and it is known that for large path imbalances the noise effects (acoustic and thermal) are increased.

In order to reduce the influence of ambient acoustic and vibrational disturbances on the interferometer, either the whole interferometer, or the delay coil (L), is encased in a noise reduction device. A schematic of such a device or arrangement is shown in FIG. 5. A substantially rigid pressure housing or enclosure 502 is made of a suitable material and shape capable of withstanding high external forces, such as a steel or aluminium cylindrical enclosure for example. Fibre input and output ports 504, 506 are provided having fibre connectors. The interferometer 508 is located within the enclosure by a number of antivibration supports 510, which may be made of rubber for example. The space within the enclosure 512 is substantially evacuated to provide a surround for the interferometer having a very high acoustic impedance.

Another embodiment of is shown in FIG. 6a. Here a Mach-Zehnder configuration is used for interferometric sensing of the laser frequency jitter. The main problem with this implementation is that the visibility is affected by the variability of the polarisation state in the interferometer and needs to be controlled via a polarisation controller (POL CNTRL). This version is somewhat cheaper than that shown in FIG. 1 and may be useful in situations where Manual control of the visibility is adopted. A digital implementation of FIG. 6 would be similar to that described with reference to FIG. 3. Again, as in previous discussion any phase demodulation technique could be used instead of a phase locked loop.

FIG. 6b shows schematically how a Mach-Zehnder configuration can be employed using Faraday rotating mirrors 650 to provide an output to a detector D1. In this way the effects of polarisation on visibility are reduced, and a polarisation controller is not required.

It will be understood that the present invention has been described above purely by way of example, and modification of detail can be made within the scope of the invention.

Each feature disclosed in the description, and (where appropriate) the claims and drawings may be provided independently or in any appropriate combination.

1. A feedback control circuit for controlling laser frequency comprising:
a laser assembly having a light output and a control input for modifying the frequency of the output light;
an interferometric phase sensor acting on said light output to produce a modulated phase output; and
a demodulator for demodulating said phase output and providing a control signal to said frequency control input to compensate for laser frequency drift;
wherein said interferometric phase sensor combines a phase modulated version of said light output, with an unmodulated version.

2. A control circuit according to claim 1, wherein said laser assembly is a fibre laser assembly.

3. A control circuit according to claim 1, wherein said interferometric sensor is a fibre interferometer.

4. A control circuit according to claim 1, wherein said interferometric sensor is a Michelson interferometer.

5. A control circuit according to claim 4, wherein a phase modulator acts on one arm of the interferometer.

6. A control circuit according to claim 5, wherein the phase modulator is a fibre-fed acousto-optic modulator.

7. A control circuit according to claim 3, wherein the interferometer includes at least one Faraday rotating mirror.

8. A control circuit according to claim 1, wherein the circuit is arranged to compensate for interferometer quadrature and laser frequency drift simultaneously.

9. A control circuit according to claim 1, wherein the demodulator comprises a phase locked loop (PLL).

10. A control circuit according to claim 1, wherein the modulated phase output from the interferometric sensor is down-converted prior to demodulation.

11. A control circuit according to claim 1, wherein the demodulator is digital.

12. A control circuit according to claim 1, wherein the modulation frequency is substantially a quarter of the digital sampling frequency.

13. A control circuit according to claim 1, wherein the interferometric sensor includes a delay coil and the delay coil is enclosed in a noise reduction casing.

14. A control circuit according to claim 13, wherein the noise reduction casing is substantially evacuated.

15. A control circuit according to claim 13, wherein the noise reduction casing is filled with a low melting point solid.

16-22. (canceled)

23. A method of producing a fibre optic component comprising the steps of
providing an enclosure having at least one input/output port;
arranging the component in the enclosure with an input/output fibre of the component passing through said at least one port;
locating the component within the enclosure using resiliently deformable spacers such that the component is free of contact with the enclosure walls; and
substantially evacuating the enclosure.

24. A method of producing a fibre optic component comprising the steps of
providing an enclosure having at least one input/output port;
arranging the component in the enclosure with an input/output fibre of the component passing through said at least one port;
filling the enclosure with a molten metal; and
allowing the metal to solidify.

25. A method according to claim 24, wherein the metal has a melting point less than or equal to 100 degrees centigrade.

26. A method according to claim 24, wherein said metal has a density greater than or equal to 7 g/cm³

27. A fibre laser sensor including a feedback control circuit according to claim 1.

28. A method for controlling the laser frequency of a laser assembly having a light output, said method comprising:
combining a phase modulated version of said light output, with an unmodulated version to produce a modulated phase output representative of the laser frequency, and
demodulating and said phase output and using said demodulated phase signal to produce a laser control signal to compensate for laser frequency drift.
